(19) United States
(12) Patent Application Publication
(10) Pub. No.: US 2025/0020142 A1
(43) Pub. Date: Jan. 16, 2025

(54) CENTRIFUGAL FAN

(71) Applicant: GRANDVANCE TECHNOLOGY, INC., Taoyuan City (TW)

(72) Inventor: CHE-WEI LEE, Taoyuan City (TW)

(21) Appl. No.: 18/765,320

(22) Filed: Jul. 7, 2024

(30) Foreign Application Priority Data
Jul. 14, 2023 (TW) 112126424

(51) Int. Cl. F04D 29/42; F04D 29/28; F04D 29/30

(52) U.S. Cl. CPC F04D 29/4226; F04D 29/281; F04D 29/30; F05D 2250/52

(57) ABSTRACT

A centrifugal fan includes a housing, a driving part and an impeller. The housing includes an air inlet, an air outlet, and an internal space. The driving part is secured to the housing, disposed in the internal space, and coaxial with the air inlet. The impeller is disposed in the internal space and coaxially connected to the driving part. The impeller includes a plurality of blades extending radially outward from a ring shaped member. Each blade of the plurality of blades includes a flow guide. A flow channel space is defined between any two adjacent blades of the plurality of blades. Each flow guide has two side flow guide vanes and at least one dividing flow guide vane. The adjacent two side flow guide vanes and the at least one dividing flow guide vane divide the corresponding flow channel space into at least two flow guide zones.

### FIELD OF THE INVENTION

The invention relates to centrifugal fans and more particularly to a centrifugal fan having improved fan efficiency at the same noise level and being easy to manufacture.

### BACKGROUND OF THE INVENTION

Referring to FIGS. 12 and 13, a conventional centrifugal fan comprises a housing 81 including an upper housing 811 and a lower housing 812. The upper housing 811 has an air inlet 81A and an air outlet 81B. An internal space 81C is defined by the upper housing 811 and the lower housing 812. The internal space 81C communicates with the air inlet 81A and the air outlet 81B.

The centrifugal fan further comprises a driving part 82 secured to the lower housing 812 and disposed in the internal space 81C. The driving part 82 is coaxial with the air inlet 81A.

The centrifugal fan further comprises an impeller 83 is disposed in the internal space 81C. The impeller 83 is coaxially connected to the driving part 82. The impeller 83 includes a ring shaped member 831 and a plurality of blades 832. The ring shaped member 831 is used for the impeller 83 to be coaxially connected to the driving part 82 and can be driven to rotate. The plurality of blades 832 extend radially outward from the ring shaped member 831. A flow channel space S is defined between any two adjacent ones of the plurality of blades 832.

Thereby, when the impeller 83 rotates, air 91 is sucked to enter the internal space 81C through the air inlet 81A, and the air 91 follows through the plurality of flow channel spaces S between the plurality of blades 32 by centrifugal force. Finally, it flows out of the fan through the air outlet 81B.

However, the conventional centrifugal fan has the following problem: it generates considerable noise during normal operation, especially when the conventional centrifugal fan is installed in a personal computer. For reducing noise, the rotation speed of the fan must be reduced (and the flow rate will also be reduced), resulting in a dilemma.

In view of this, it is necessary to develop technology for solving the problem created by the conventional centrifugal fan.

### SUMMARY OF THE INVENTION

The purpose of the invention is to provide a centrifugal fan that has advantages of improved fan efficiency at the same noise level and being easy to manufacturing. In particular, the problem that the invention aims to solve is as follows. The conventional centrifugal fan generates considerable noise during normal operation. For reducing noise, the rotation speed must be reduced (and the flow rate will also be reduced), resulting in a dilemma.

The technical means to solve the above problem is to provide a centrifugal fan comprising a housing including a lower housing, an upper housing having an air inlet and an air outlet, and an internal space defined by the upper housing and the lower housing, the internal space communicating with the air inlet and the air outlet; a driving part secured to the lower housing, disposed in the internal space, and being coaxial with the air inlet; and an impeller disposed in the internal space and coaxially connected to the driving part, the impeller including a ring shaped member for coaxially connecting the impeller to the driving part, the ring shaped member being configured to drive for rotation, and a plurality of blades extending radially outward from the ring shaped member wherein each blade of the plurality of blades include a flow guide, a flow channel space is defined between any two adjacent blades of the plurality of blades, each flow guide has two side flow guide vanes and at least one dividing flow guide vane, and the adjacent two side flow guide vanes and the at least one dividing flow guide vane are configured to divide the corresponding flow channel space into at least two flow guide zones; and wherein the at least one dividing flow guide vane and the two side flow guide vanes of the adjacent blade are separated and not connected to each other.

The above and other objects, features and advantages of the invention will become apparent from the following detailed description taken with the accompanying drawings.

### BRIEF DESCRIPTION OF DRAWINGS

FIG. 1 is an exploded view of a centrifugal fan according to a first preferred embodiment of the invention;

FIG. 2 is a perspective view of the assembled centrifugal fan in FIG. 1;

FIG. 3 is an enlarged view of some components in FIG. 1;

FIG. 4 is a front view of the components in FIG. 3;

FIG. 5 is an exploded view of the components in FIG. 3;

FIG. 6 is a fragmented view of some components in FIG. 3;

FIG. 7 is another fragmented view of some components in FIG. 3;

FIG. 8 is a perspective view of some components in FIG. 3;

FIG. 9 is a perspective view of some components in FIG. 3 according to a second preferred embodiment of the invention;

FIG. 10A is a longitudinal sectional view of some components according to the first preferred embodiment;

FIG. 10B is a perspective view of the flow channel space and the flow guide zone in FIG. 10A;

FIG. 11A is a longitudinal sectional view of some components according to the second preferred embodiment;

FIG. 11B is a perspective view of the flow channel space and the flow guide zone in FIG. 11A;

FIG. 12 is a perspective view of the conventional centrifugal fan; and

FIG. 13 is an enlarged view of some components in FIG. 12.

### DETAILED DESCRIPTION OF THE INVENTION

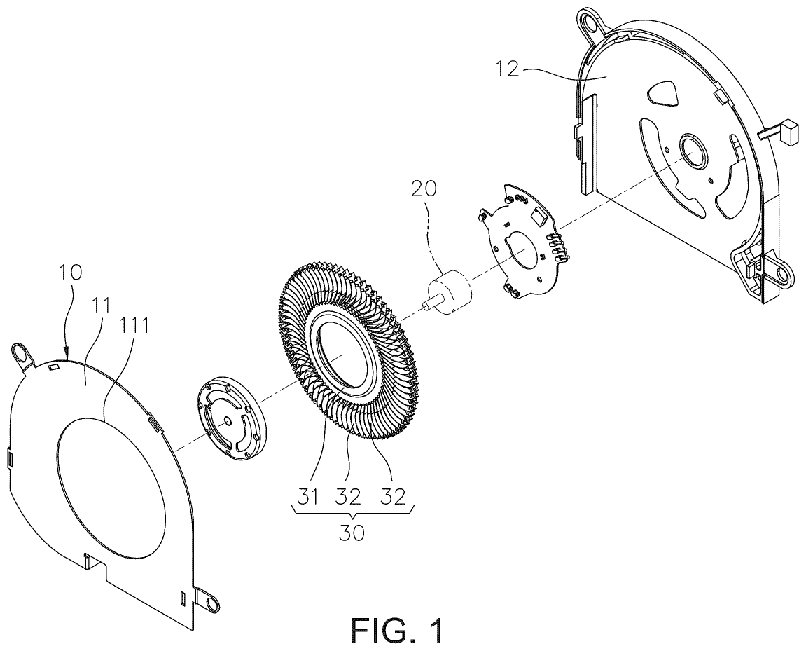

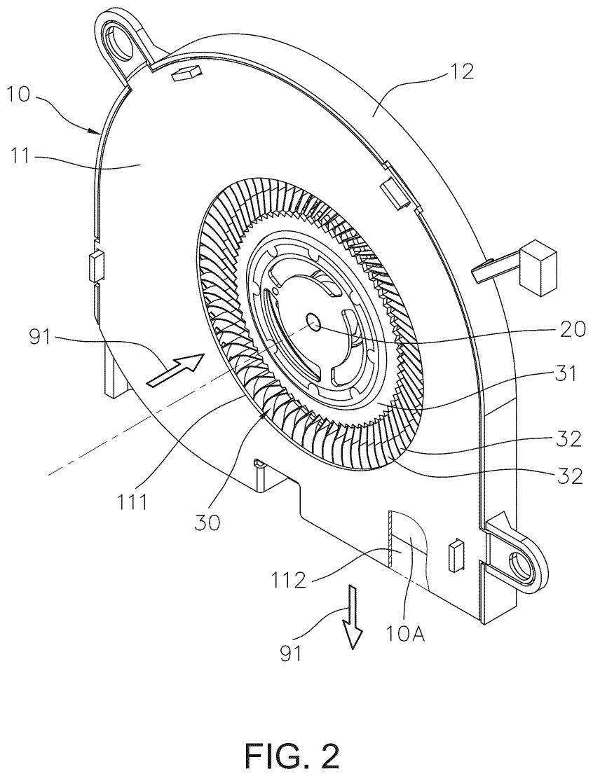

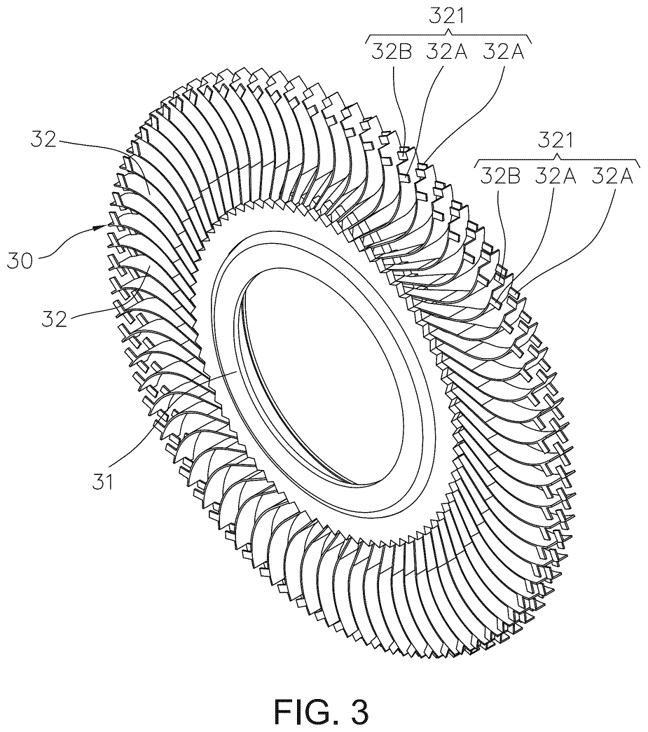

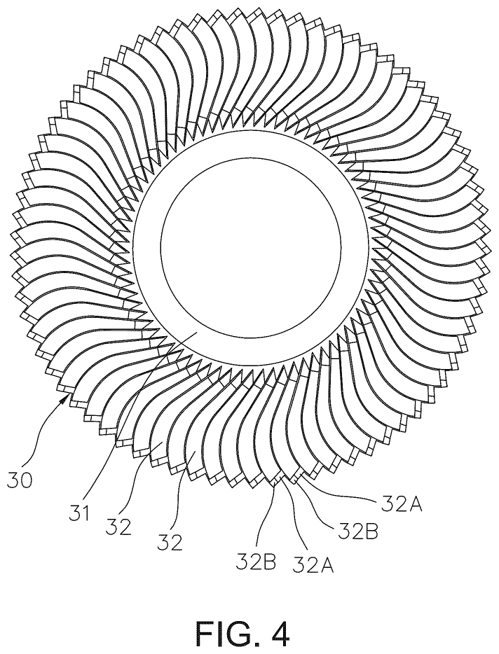

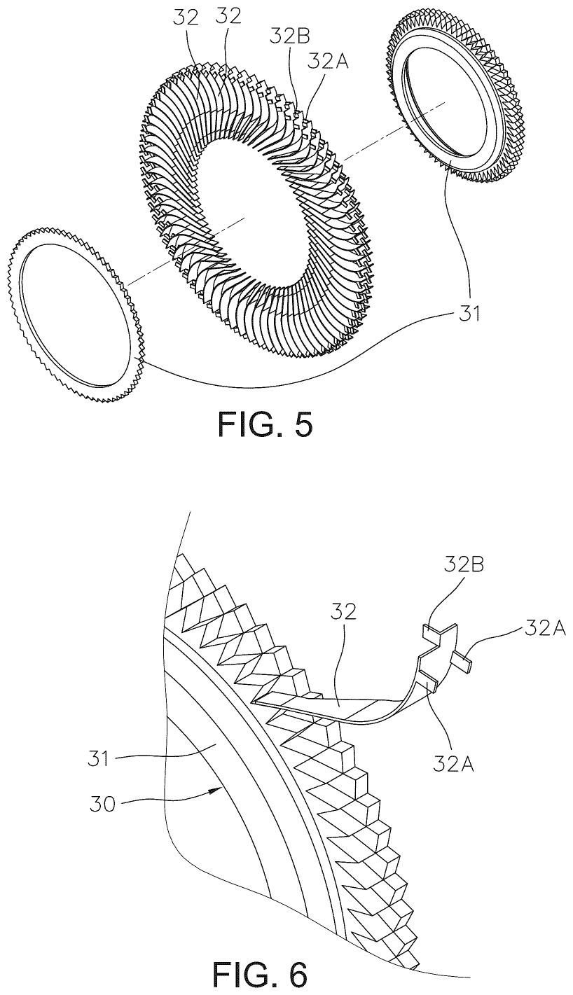

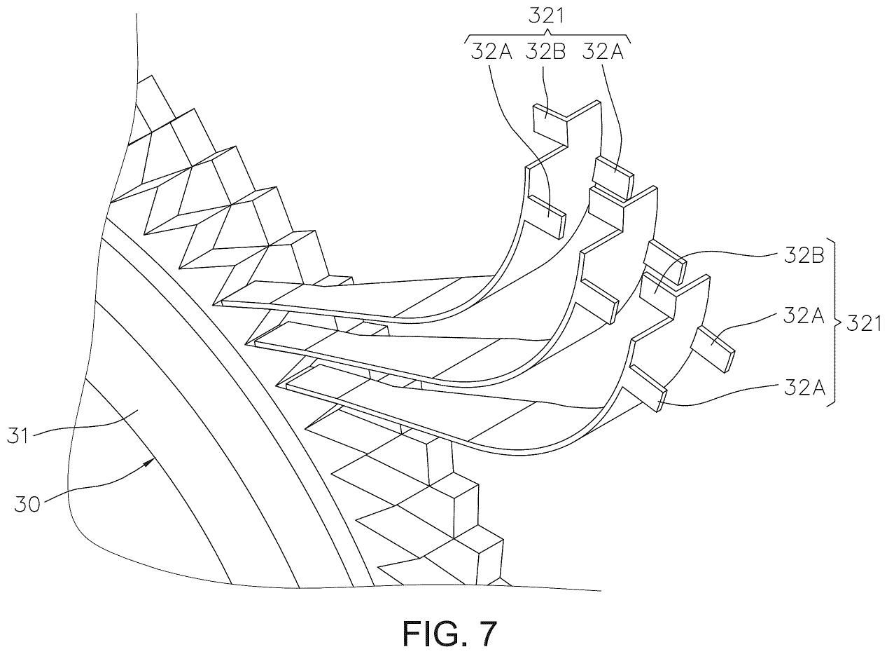

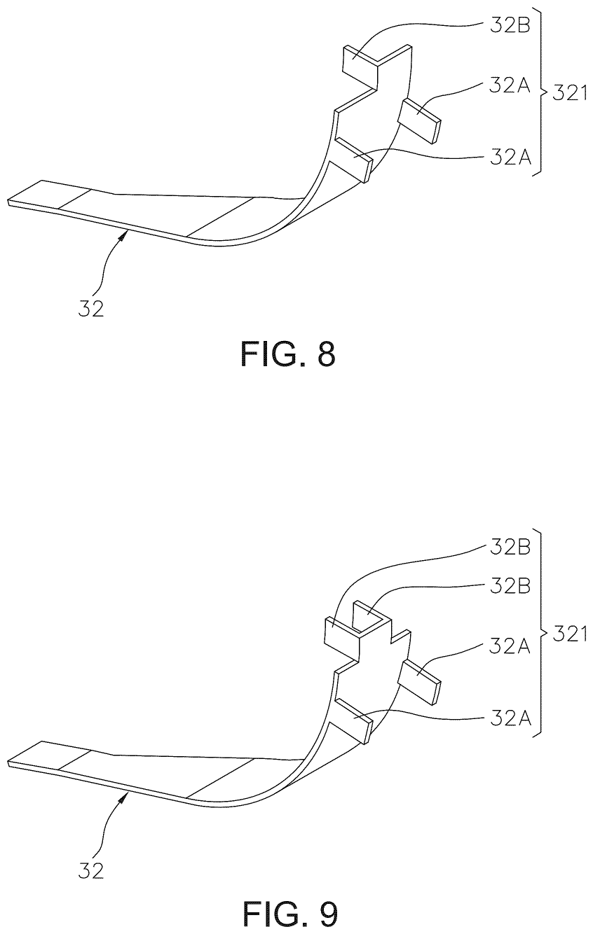

Referring to FIGS. 1 to 8, a centrifugal fan in centrifugal fan in accordance with a first preferred embodiment of the invention comprises the following components as discussed in detail below.

A housing 10 includes an upper housing 11 and a lower housing 12. The upper housing 11 has an air inlet 111 and an air outlet 112. An internal space 10A is defined by the upper housing 11 and the lower housing 12. The internal space 10A communicates with the air inlet 111 and the air outlet 112.

A driving part 20 is secured to the lower housing 12, disposed in the internal space 10A, and coaxial with the air inlet 111.

An impeller 30 is disposed in the internal space 10A and coaxially connected to the driving part 20. The impeller 30 includes a ring shaped member 31 and a plurality of blades 32. The ring shaped member 31 is used to coaxially connect the impeller 30 to the driving part 20 and can be driven to rotate. The plurality of blades 32 extend radially outward from the ring shaped member 31. Each blade 32 of the plurality of blades 32 include a flow guide 321. A flow channel space S is defined between any two adjacent blades 32 of the plurality of blades 32.

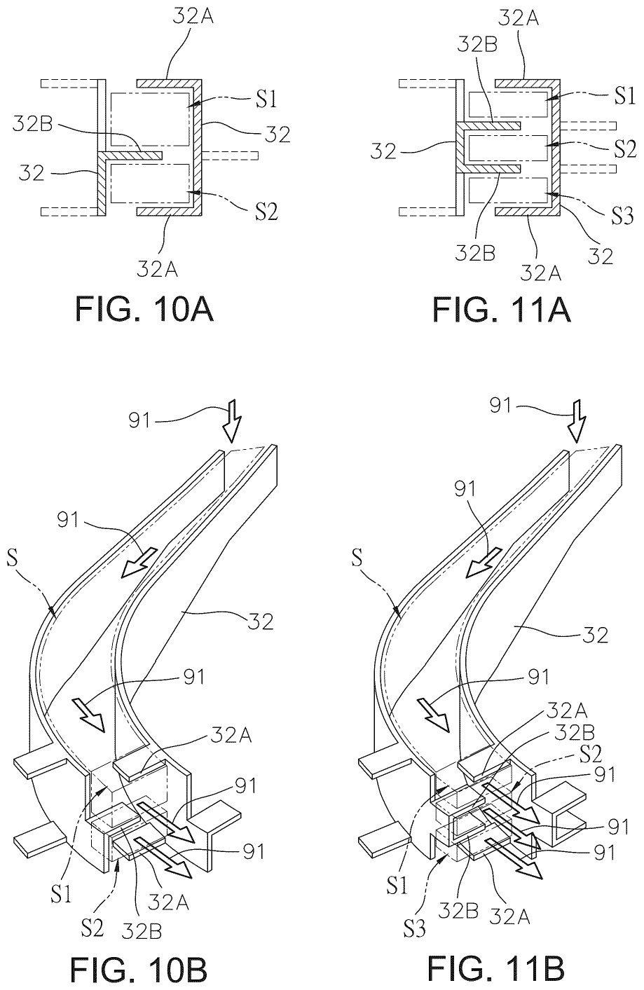

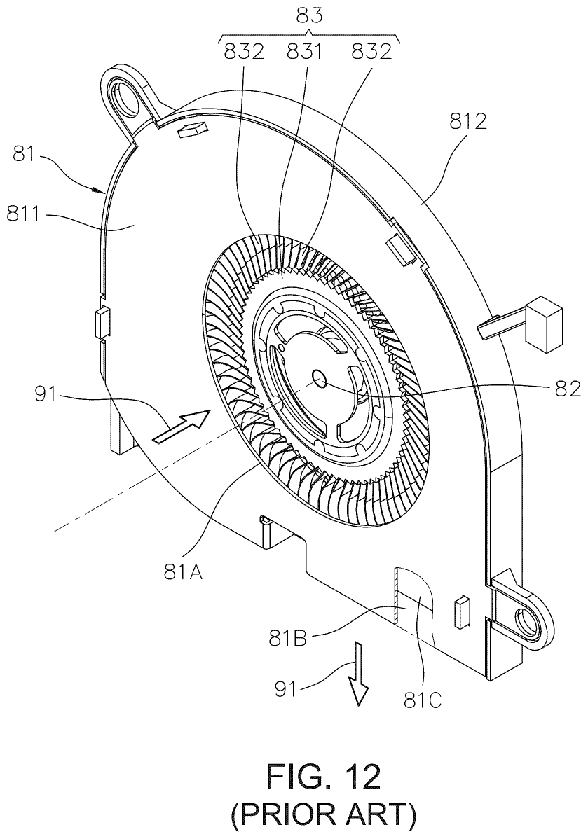

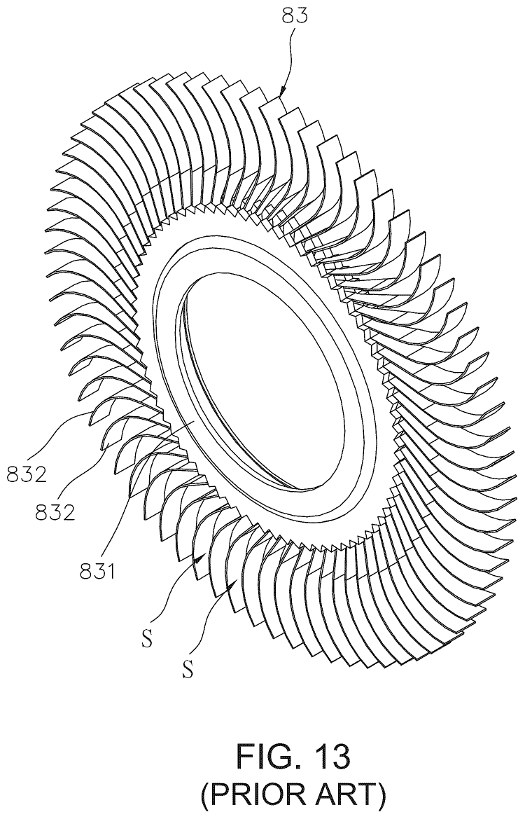

Each of the above flow guides 321 have two side flow guide vanes 32A and at least one dividing flow guide vane 32B. The adjacent two side flow guide vanes 32A and the at least one dividing flow guide vane 32B are used to divide the corresponding flow channel space S into at least two flow guide zones (e.g., a first flow guide zone S1 and a second flow guide zone S2 are shown in FIGS. 10A and 10B, or a first flow guide zone S1, a second flow guide zone, and a third flow guide zone S3 as shown in FIGS. 11A and 11B), thereby improving a flow guide effect. The at least one dividing flow guide vane 32B and the two side flow guide vanes 32A of the adjacent blade 32 are separated and not connected to each other.

In practice, each flow guide 321 can be disposed at an end of each blade 32 or adjacent to the end thereof.

When the impeller 30 rotates, air 91 is sucked into the internal space 10A through the air inlet 111. The air 91 passes the plurality of blades 32 by a centrifugal force and flows through the at least two flow guide zones (e.g., the first flow guide zone S1 and the second flow guide zone S2 as shown in FIGS. 10A and 10B). Finally, the air 91 flows out of the air outlet 112. As a result, an effect of guiding flow is created.

Regarding the first embodiment of the invention (as shown in FIGS. 10A and 10B), the two side flow guide vanes 32A extend from a first direction corresponding to the blade 32. The at least one dividing flow guide vane 32B extends from a second direction corresponding to the blade 32. The second direction is opposite to the first direction.

The two side flow guide vanes 32A and the at least one dividing flow guide vane 32B are parallel to each other, thereby dividing the corresponding flow channel space S into the at least two flow guide zones, thereby improving the flow guide effect.

The at least two flow guide zones include a first flow guide zone S1 and a second flow guide zone S2.

Referring to FIG. 9, a second preferred embodiment of the invention is shown. The only difference between the first embodiment and the second embodiment is that the number of the at least one dividing guide vane 32B is two (as shown in FIGS. 11A and 11B). Similarly, the corresponding flow channel space S is divided into at least two flow guide zones. This also improves the flow guide effect. Specifically, the at least two flow guide zones include the first flow guide zone S1, the second flow guide zone S2, and a third flow guide zone S3.

What needs special attention is that the conventional centrifugal fan generates considerable noise during normal operation, especially when the conventional centrifugal fan is installed in a personal computer. The noise is very great. For reducing noise, the speed must be reduced (and the flow rate will also be reduced). For solving the above problem, each blade 32 of the plurality of blades 32 of the invention are provided with a flow guide 321. In this way, when the centrifugal fan of the invention is started, generated noise, pressure difference, flow rate and rotational speed are recorded and the same of the conventional centrifugal fan is also recorded as tabulated in Table 1 below.

TABLE 1

| | Conventional | The |
|---|---|---|
| Item | centrifugal fan | invention |
| Rotational speed (RPM) | 6100 | 6660 |
| Flow rate (CFM) | 2.63 | 2.72 |
| Pressure difference (Pa) | 97.4 | 111.3 |
| Noise (dB) | 48.9 | 48.9 |

It can be clearly seen from the Table 1 above, for the invention the flow rate (CFM) is 2.72 and for the conventional centrifugal fan the flow rate (CFM) is 2.63 when they operate at the same noise level (e.g., 48.9 dB). That is, the flow rate is increased about 3.4%.

Similarly, for the invention the pressure difference (Pa) is 111.3 and for the conventional centrifugal fan the pressure difference (Pa) is 97.4 when they operate at the same noise level (e.g., 48.9 dB). That is, the pressure difference is increased about 19.3%. This also proves that the invention has a higher quality in comparison the conventional centrifugal fan.

The invention has the following advantages and benefits in comparison with the conventional art:

Improved fan efficiency at the same noise level. Regarding the invention, each blade of the plurality of blades is provided with a flow guide. When the centrifugal fan of the invention is started and generates a noise level of 48.9 (dB), and the conventional centrifugal fan is also started and generates the same noise level of 48.9 (dB), the flow rate of the centrifugal fan of the invention is increased by about 3.4% in comparison with the conventional centrifugal fan, and the pressure difference of the centrifugal fan of the invention is increased by about 19.3% in comparison with the conventional centrifugal fan. Therefore, the efficiency of the centrifugal fan of the invention is improved in terms of noise level.

Easy to manufacture. Regarding the invention, the guide part is only provided at the end of each blade. This is a technology that can be carried out simultaneously during the blade stamping process. It can be implemented without any difficulty for those skilled in the art. Therefore, it is easy to manufacture.

While the invention has been described in terms of preferred embodiments, those skilled in the art will recognize that the invention can be practiced with modifications within the spirit and scope of the appended claims.

What is claimed is:

1. A centrifugal fan, comprising:
a housing including a lower housing, an upper housing having an air inlet and an air outlet, and an internal space defined by the upper housing and the lower housing, the internal space communicating with the air inlet and the air outlet;
a driving part secured to the lower housing, disposed in the internal space, and being coaxial with the air inlet; and
an impeller disposed in the internal space and coaxially connected to the driving part, the impeller including a ring shaped member for coaxially connecting the impeller to the driving part, the ring shaped member being configured to drive for rotation, and a plurality of blades extending radially outward from the ring shaped member wherein each blade of the plurality of blades include a flow guide, a flow channel space is defined between any two adjacent blades of the plurality of blades, each flow guide has two side flow guide vanes and at least one dividing flow guide vane, and the adjacent two side flow guide vanes and the at least one dividing flow guide vane are configured to divide the corresponding flow channel space into at least two flow guide zones; and wherein the at least one dividing flow guide vane and the two side flow guide vanes of the adjacent blade are separated and not connected to each other.

2. The centrifugal fan of claim 1, wherein when the impeller rotates, air is sucked into the internal space through the air inlet, the air passes the plurality of blades by a centrifugal force, flows through the at least two flow guide zones, and flows out of the air outlet.

3. The centrifugal fan of claim 1, wherein the two side flow guide vanes extend from a first direction corresponding to the blade; the at least one dividing flow guide vane extends from a second direction corresponding to the blade, the second direction being opposite to the first direction; the two side flow guide vanes and the at least one dividing flow guide vane are parallel to each other, thereby dividing the corresponding flow channel space into the at least two flow guide zones; and the least two flow guide zones include a first flow guide zone and a second least flow guide zone.

4. The centrifugal fan of claim 1, wherein the two side flow guide vanes extend from a first direction corresponding to the blade; the number of the at least one dividing flow guide vane is two; the two dividing flow guide vanes is two extend from a second direction corresponding to the blade, the second direction being opposite to the first direction; the two side flow guide vanes and the two dividing flow guide vanes are parallel to each other, thereby dividing the corresponding flow channel space into the at least two flow guide zones; and the least two flow guide zones include a first flow guide zone, a second flow guide zone, and a third flow guide zone.
